(19) United States
(12) Patent Application Publication
(10) Pub. No.: US 2012/0015139 A1
(43) Pub. Date: Jan. 19, 2012

(54) Void Filler Panel

(76) Inventor: Paul Wesley Baker, Cambridge, OH (US)

(21) Appl. No.: 12/835,304

(22) Filed: Jul. 13, 2010

(51) Int. Cl. B32B 3/12; B32B 37/14

(52) U.S. Cl. 428/116; 156/242

(57) ABSTRACT

A void filler panel including a first major wall, a second major wall spaced apart from the first major wall and pillars extending between the first and second major walls, wherein the first major wall, the second major wall and the plurality of pillars are formed from a polymeric material.

### FIELD

This application relates to void fillers and, more particularly, to void filler panels formed from polymeric materials.

### BACKGROUND

Cargo is typically shipped in large vessels, such as trucks, cargo containers, railway boxcars and the like. Prior to shipping, the cargo is often secured onto pallets, such as a 40 inch by 48 inch pallet. These pallets are then loaded in the shipping vessel in a manner that maximizes the use of available space in the vessel. For example, shipping vessels are commonly loaded with two rows of double-stacked pallets.

Despite the best attempts to maximize the available space in shipping vessels, there is often void space between the cargo. Unless such void space is filled, the cargo is prone to movement during shipping, which may result in damage to the cargo. As such, various void fillers have been used to fill void space in shipping vessels.

Conventional void fillers commonly include a honeycomb structure formed from paperboard. Optionally, a sheet or decking is applied to opposite sides of the honeycomb structure to provide a continuous surface. The paperboard forming the honeycomb structure is provided with a sufficient thickness to impart the honeycomb structure with the required compression strength.

Paperboard-based honeycomb void fillers are generally used once or twice and then are discarded. Therefore, paperboard-based honeycomb void fillers present ongoing expenses associated with the purchase of new void fillers and the disposal of used void fillers. Furthermore, such paperboard-based honeycomb void fillers lose their compression strength when they are stacked, thereby requiring the use of void fillers of various thicknesses to accommodate various situations.

Accordingly, those skilled in the art continue to seek new solutions for filling the voids between cargo.

### SUMMARY

In one aspect, the disclosed void filler panel may include a first major wall, a second major wall spaced apart from the first major wall and a plurality of pillars extending between the first and second major walls, wherein the first major wall, the second major wall and the plurality of pillars are formed from a polymeric material.

In another aspect, the disclosed void filler panel may include a first major wall that defines a plurality of first protuberances, a second major wall spaced apart from the first major wall, the second major wall defining a plurality of second protuberances, and a plurality of pillars extending between the first and second major walls, each pillar comprising at least one of the first protuberances connected to at least one of the second protuberances, wherein the first major wall, the second major wall and the plurality of pillars are formed from a polymeric material.

In yet another aspect, disclosed is a method for forming a void filler panel using a thermoforming machine having at least a first mold and a second mold. The method may include the steps of (1) heating a first sheet of polymeric material and a second sheet of polymeric material, (2) shaping the first sheet of heated polymeric material to include a first outer surface and a plurality of first protuberances extending from the first outer surface, (3) shaping the second sheet of heated polymeric material to include a second outer surface and a plurality of second protuberances extending from the second outer surface and (4) pressing the first shaped sheet into contact with the second shaped sheet to fuse each of the first protuberances with a corresponding one of the second protuberances.

Other aspects of the disclosed void filler panel and method for forming a void filler panel will become apparent from the following description, the accompanying drawings and the appended claims.

### BRIEF DESCRIPTION OF THE DRAWINGS

FIG. 1 is a front perspective view of one aspect of the disclosed void filler panel;

FIG. 2 is a top plan view of the void filler panel of FIG. 1;

FIG. 3 is a front elevational view of the void filler panel of FIG. 1;

FIG. 4 is a front elevational view, in section, of the void filler panel of FIG. 3;

FIG. 5 is a schematic front elevational view, in section, of a portion of the void filler panel of FIG. 4;

FIG. 6A is a schematic side elevational view of a portion of an assembly for thermoforming the disclosed void filler; and

FIG. 6B is a schematic side elevational view of the assembly of FIG. 6A after thermoforming.

### DETAILED DESCRIPTION

Disclosed is a void filler panel formed from one or more polymeric materials using, for example, a thermoforming process. The polymeric materials forming the disclosed void filler panel may render the void filler panel durable and reusable. Furthermore, the structure of the disclosed void filler panel may provide relatively high compression strength (e.g., greater than 10.4 pounds per square inch), and the compression strength may be preserved upon stacking multiple panels.

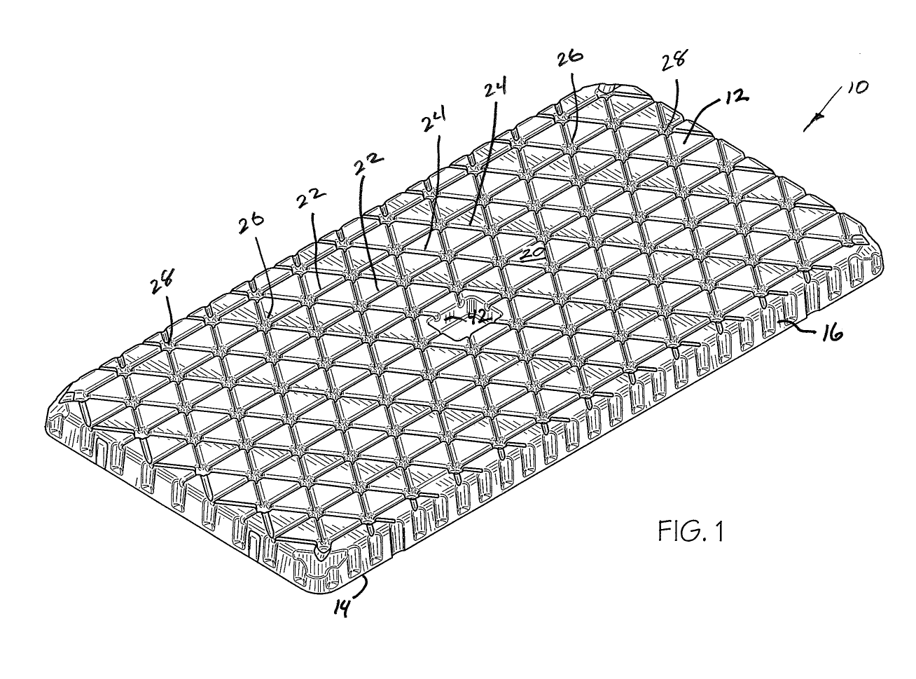

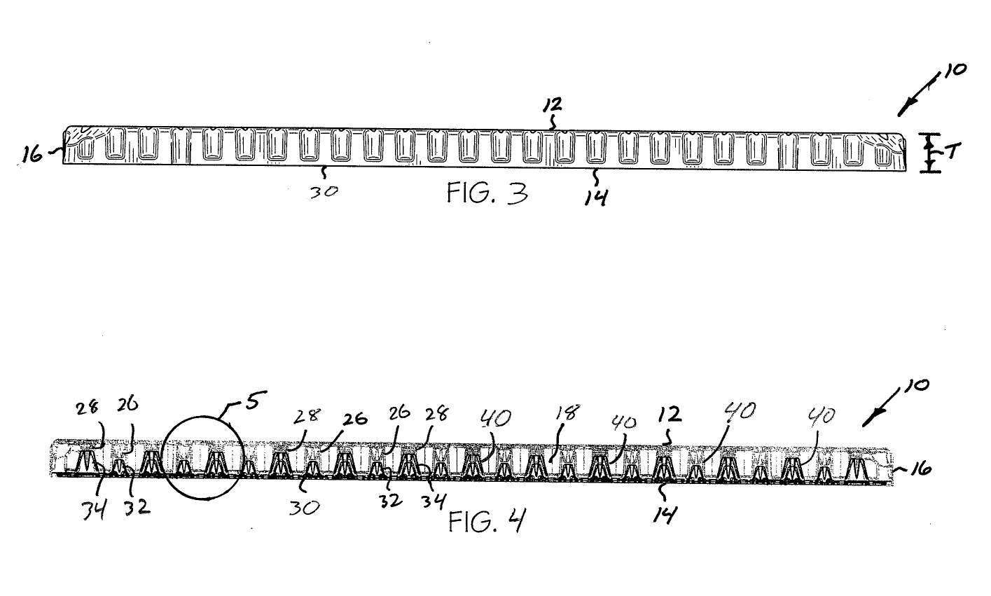

Referring to FIGS. 1-5, one aspect of the disclosed void filler panel, generally designated 10, may include a first major wall 12, a second major wall 14 and, optionally, a side wall 16. The side wall 16 may connect the first major wall 12 to the second major wall 14 to define an internal volume 18 within the void filler panel 10. The internal volume 18 may be fully enclosed and may be filled with air to reduce the overall weight of the void filler panel 10. Furthermore, the side wall 16 may space the first major wall 12 apart from the second major wall 14 to provide the void filler panel 10 with a desired cross-sectional thickness T.

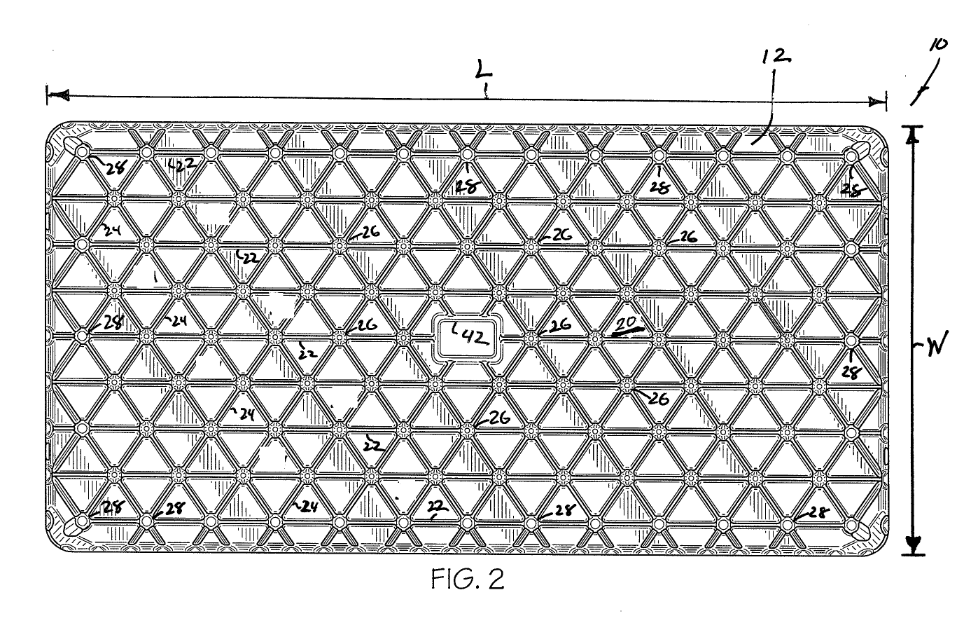

Optionally, at least one opening 42 may extend through the first 12 and second 14 major walls to provide a handle for gripping the void filler panel 10. While the opening 42 is shown in FIGS. 1 and 2 as being in the center of the void filler panel 10, it will be appreciated that the opening 42 may be positioned at various locations on the void filler panel 10.

The first major wall 12, the second major wall 14 and the side wall 16 may be formed from polymeric materials. One example of a useful polymeric material for forming the disclosed void filler panel 10 is high density polyethylene (“HDPE”). However, those skilled in the art will appreciate that various polymeric materials and combinations of polymeric materials may used without departing from the scope of the present disclosure. For example, the polymeric material forming the void filler panel 10 may be selected to provide additional functionality based on the intended end use of the void filler panel 10.

In one particular expression, the void filler panel 10 may be formed as a three-dimensional rectilinear body having a length L, a width W and the cross-sectional thickness T. For example, the first 12 and second 14 major walls of the void filler panel 10 may be generally rectangular in plan view (FIG. 2) and may have a length L ranging from about 32 inches to about 192 inches, such as about 96 inches, and a width W ranging from about 16 inches to about 96 inches, such as about 48 inches. Furthermore, the cross-sectional thickness T of the void filler panel 10 may range, for example, from about 1 to about 12 inches. As a specific example, the cross-sectional thickness T of the void filler panel 10 may be about 4 inches.

The first major wall 12 may be, for example, a front wall, and may define a first major outer surface 20 of the void filler panel 10. As shown in FIGS. 1 and 2, the first major wall 12 may define a plurality of longitudinal channels 22 (only several are numbered in the drawings) and a plurality of transverse channels 24 (only several are numbered in the drawings) to provide the first major outer surface 20 with adequate deck stiffness. The longitudinal 22 and transverse 24 channels may be recessed from the first major outer surface 20 into the internal volume 18 of the void filler panel 10. For example, the longitudinal 22 and transverse 24 channels may have a recess depth ranging from about ¼ inch to about 1.5 inches, such as about ½ inch.

Optionally, various features and textures may be used to provide the first major outer surface 20 with non-skid functionality. For example, a non-skid material may be laminated or coextruded onto the first major outer surface 20 (e.g., before thermoforming) to provide the first major outer surface 20 with non-skid functionality.

The first major wall 12 may also define a plurality of protuberances 26, 28 (only several are numbered in the drawings) that extend (e.g., generally perpendicularly) from the first major outer surface 20 into the internal volume 18 of the void filler panel 10. In one particular expression, the protuberances 26, 28 may be generally equidistantly spaced from each other. For example, as shown in FIG. 2, the protuberances 26, 28 may be located where the longitudinal channels 22 intersect with the transverse channels 24.

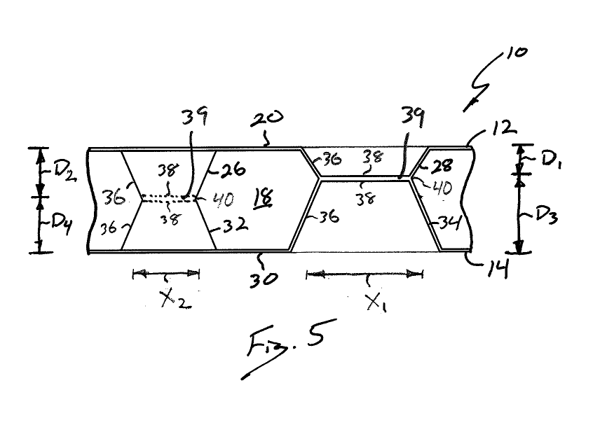

Referring to FIG. 5, each protuberance 26, 28 may have a maximum depth D and a minimum width X. In one implementation, the protuberances 28 located about the periphery of the void filler panel 10 may be different than the other protuberances 26 of the void filler panel 10. Specifically, protuberances 28 may have a maximum depth D₁ that is less than the maximum depth D₂ of protuberances 26, and a minimum width X₁ that is greater than the minimum width X₂ of protuberances 26. For example, protuberances 28 may have a maximum depth D₁ ranging from about 0 to about 40 percent of the cross-sectional thickness T of the void filler panel 10, such as about 1.5 inches, and a minimum width X₁ ranging from about 0.5 to about 5 times the maximum depth D₁, such as about 1 inch. Protuberances 26 may have a maximum depth D₂ ranging from about 0 to about 50 percent of the cross-sectional thickness T of the void filler panel 10, such as about 2 inches, and a minimum width X₂ ranging from about 0.5 to about 2 times the maximum depth D₂, such as about 1 inch.

The second major wall 14 may be, for example, a rear wall, and may define a second major outer surface 30 of the void filler panel 10. Like the first major wall 12, the second major wall 14 may define a plurality of longitudinal channels and a plurality of transverse channels to provide the second major outer surface 30 with adequate deck stiffness.

Like the first major outer surface 20, the second major outer surface 30 may optionally be provided with non-skid functionality.

In one particular expression, the first 20 and second 30 major outer surfaces of the first 12 and second 14 major walls may be generally flat, planar surfaces, and may be generally parallel with each other. Other configurations of the first 20 and second 30 major outer surfaces may be dictated by the intended application of the void filler panel 10.

As shown in FIGS. 4 and 5, the second major wall 14 may also define a plurality of protuberances 32, 34 (only several are numbered in the drawings) that extend (e.g., generally perpendicularly) from the second major outer surface 30 into the internal volume 18 of the void filler panel 10. Like protuberances 26, 28 of the first major wall 12, protuberances 32, 34 may be generally equidistantly spaced from each other and/or may be located where the longitudinal channels intersect with the transverse channels.

Referring to FIG. 5, each protuberance 32, 34 may have a maximum depth D and a minimum width X. In one implementation, the protuberances 34 located about the periphery of the void filler panel 10 may be different than the other protuberances 32 of the void filler panel 10. Specifically, protuberances 34 may have a maximum depth D₃ that is greater than the maximum depth D₄ of protuberances 32, and a minimum width X₁ that is greater than the minimum width X₂ of protuberances 32. For example, protuberances 34 may have a maximum depth D₃ ranging from about 60 to about 100 percent of the cross-sectional thickness T of the void filler panel 10, such as about 2.5 inches and a minimum width X₁ ranging from about 0.2 to about 1 times the maximum depth D₃, such as about 1 inch. Protuberances 32 may have a maximum depth D₄ ranging from about 50 to about 100 percent of the cross-sectional thickness T of the void filler panel 10, such as about 2 inches and a minimum width X₂ ranging from about 0.5 to about 2 times the maximum depth D₄, such as about 1 inch.

While the protuberances 26, 28, 32, 34 are shown in the drawings, particularly in FIG. 5, as frusto-conical protuberances having a side wall 36 and a base 38, those skilled in the art will appreciate that the protuberances 26, 28, 32, 34 may be formed into various shapes (e.g., cylindrical protuberances) and may have various depth and width dimensions without departing from the scope of the present disclosure. In particular, those skilled in the art will appreciate that the number, spacing, shape and dimension of the protuberances 26, 28, 32, 34 may be optimized to provide the void filler panel 10 with the desired compression strength using a minimum amount of polymeric material to form the void filler panel 10.

Referring again to FIGS. 4 and 5, the protuberances 26, 28 of the first major wall 12 may be aligned with, and connected to, corresponding protuberances 32, 24 of the second major wall 12 to define a plurality of pillars 40 (only several are numbered in the drawings) extending between the first 12 and second 14 major walls. Specifically, the pillars 40 may be defined by protuberances 26 of the first major wall 12 being connected to the protuberances 32 of the second major wall 14, and the protuberances 28 of the first major wall 12 being connected to the protuberances 34 of the second major wall 14. For example, the bases 38 of the protuberances 26, 28 of the first major wall 12 may be heat-fused to the bases 38 of the protuberances 32, 34 of the second major wall 14 at a heat-fused joint 39 (FIG. 5).

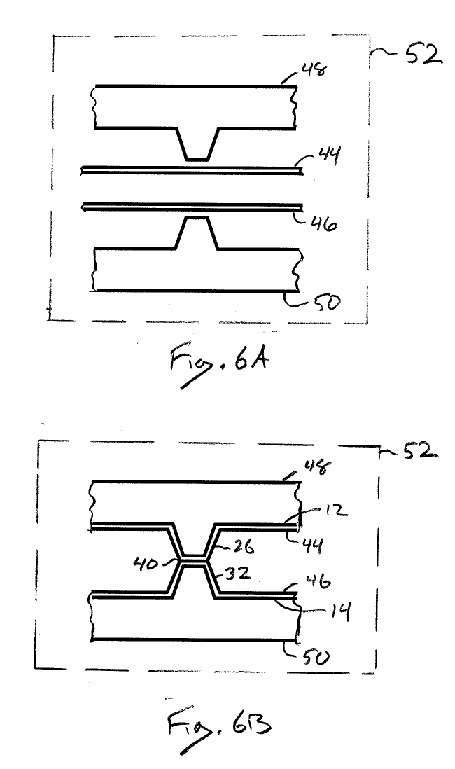

Referring to FIGS. 6A and 6B, in one particular implementation, the disclosed void filler panel 10 may be formed using a thermoforming process. As shown in FIG. 6A, two sheets 44, 46 of heated polymeric material (e.g., high density polyethylene) may be positioned between the molds 48, 50 of a thermoforming machine 52. The first sheet 44 may have a greater cross-sectional thickness than the second sheet 46 to provide sufficient polymeric material to form the side wall 16 (FIG. 1). For example, the first sheet 44 may have a cross-sectional thickness of about 0.135 inches and the second sheet 46 may have a cross-sectional thickness of about 0.110 inches.

As shown in FIG. 6B, the sheets 44, 46 may be shaped by the corresponding molds 48, 50 (e.g., by vacuum drawing the sheets 44, 46 onto the molds 48, 50), thereby defining the various features of the first 12 and second 14 major walls, including the protuberances 26, 32 and the side wall 16 (FIG. 1). Then, the molds 48, 50 may be approximated such that heat and pressure fuse the protuberances 26, 32 together to form the pillars 40. As the various features are formed, the cross-sectional thicknesses of the sheets 44, 46 may be reduced. For example, after thermoforming, the first 12 and second 14 major walls, as well as the optional side wall 16, may be have a cross-sectional thickness ranging from about 0.060 to about 0.080 inches.

Accordingly, the pillars 40 of the disclosed void filler panel 10 may reinforce the spacing between the first 12 and second 14 major walls, thereby providing the void filler panel 10 with significantly greater compression strength than can be achieved without the pillars 40. At this point, those skilled in the art will also appreciate that the compression strength of the disclosed void filler panel 10 may be a function of, among other things, the type of polymeric material used to form the void filler panel 10, the total number of pillars 40, the spacing of the pillars 40, the size and shape of the pillars 40, as well as the cross-sectional thickness of the first 12, second 14 and side 16 walls.

Although various aspects of the disclosed void filler panel have been shown and described, modifications may occur to those skilled in the art upon reading the specification. The present application includes such modifications and is limited only by the scope of the claims.

What is claimed is:

1. A void filler panel comprising:
a first major wall;
a second major wall spaced apart from said first major wall; and
a plurality of pillars extending between said first and said second major walls,
wherein said first major wall, said second major wall and said plurality of pillars are formed from a polymeric material.

2. The void filler panel of claim 1 wherein said first major wall defines a generally planar first outer surface and said second major wall defines a generally planar second outer surface, and wherein said first outer surface is generally parallel with said second outer surface.

3. The void filler panel of claim 2 wherein said first outer surface is spaced at least 4 inches from said second outer surface.

4. The void filler panel of claim 2 wherein at least one of said first and said second outer surfaces comprises non-skid treatment.

5. The void filler panel of claim 1 formed as a rectilinear body.

6. The void filler panel of claim 1 wherein said polymeric material comprises high density polyethylene.

7. The void filler panel of claim 1 wherein said first major wall and said second major wall define a volume therebetween, and wherein said volume is filled with air.

8. The void filler panel of claim 1 further comprising a side wall connecting an outer periphery of said first major wall to an outer periphery of said second major wall.

9. The void filler panel of claim 1 wherein said first and said second major walls are generally rectangular in plan view.

10. The void filler panel of claim 9 wherein first and said second major walls have a length of at least 96 inches and a width of at least 48 inches.

11. The void filler panel of claim 1 wherein said first major wall defines a plurality of first protuberances and said second major wall defines a plurality of second protuberances, and wherein each pillar of said plurality of pillars comprises at least one protuberance of said plurality of first protuberances connected to at least one protuberance of said plurality of second protuberances.

12. The void filler panel of claim 11 wherein said protuberance of said plurality of first protuberances is connected to said protuberance of said plurality of second protuberances at a heat-fused joint.

13. The void filler panel of claim 11 wherein at least one of said protuberance of said plurality of first protuberances and said protuberance of said plurality of second protuberances is a frusto-conical protuberance.

14. The void filler panel of claim 11 wherein said protuberance of said plurality of first protuberances has a maximum depth in a range from about 20 to about 80 percent of a thickness of said void filler panel and said protuberance of said plurality of second protuberances has a maximum depth in a range from about 20 to about 80 percent of said thickness.

15. The void filler panel of claim 1 wherein each pillar of said plurality of pillars is generally equidistantly spaced from adjacent pillars of said plurality of pillars.

16. The void filler panel of claim 1 wherein at least one of said first major wall and said second major wall defines a plurality of reinforcing channels.

17. The void filler panel of claim 16 wherein said plurality of reinforcing channels comprises at least two generally parallel channels and at least one channel transverse to said generally parallel channels.

18. A void filler panel comprising:
a first major wall that defines a plurality of first protuberances;
a second major wall spaced apart from said first major wall, said second major wall defining a plurality of second protuberances; and
a plurality of pillars extending between said first and said second major walls, each pillar of said plurality of pillars comprising at least one protuberance of said plurality of first protuberances connected to at least one protuberance of said plurality of second protuberances,
wherein said first major wall, said second major wall and said plurality of pillars are formed from a polymeric material.

19. A method for forming a void filler panel using a thermoforming machine having at least a first mold and a second mold, said method comprising the steps of:
heating a first sheet of polymeric material and a second sheet of polymeric material;
shaping said first sheet of heated polymeric material to include a first outer surface and a plurality of first protuberances extending from said first outer surface;
shaping said second sheet of heated polymeric material to include a second outer surface and a plurality of second protuberances extending from said second outer surface;
pressing said first shaped sheet into contact with said second shaped sheet to fuse said plurality of first protuberances with corresponding protuberances of said plurality of second protuberances.

20. The method of claim 19 wherein said first and said second sheets of polymeric material comprise high density polyethylene.
